(19) United States
(12) Patent Application Publication
(10) Pub. No.: US 2013/0038545 A1
(43) Pub. Date: Feb. 14, 2013

(54) TOUCH-SENSING PANEL AND TOUCH-SENSING DISPLAY APPARATUS

(71) Applicants: Fu-Min Hsu, Taichung City (TW); Chih-Jung Teng, Taichung City (TW); Kuo-Chang Su, Tainan City (TW); Chih-Yao Fang, Taichung City (TW)

(72) Inventors: Fu-Min Hsu, Taichung City (TW); Chih-Jung Teng, Taichung City (TW); Kuo-Chang Su, Tainan City (TW); Chih-Yao Fang, Taichung City (TW)

(73) Assignees: WINTEK CORPORATION, Taichung City (TW); WINTEK (CHINA) TECHNOLOGY LTD., Guangdong Province (CN)

(21) Appl. No.: 13/533,968

(22) Filed: Jun. 27, 2012

(30) Foreign Application Priority Data
Aug. 12, 2011 (TW) 100128937

(51) Int. Cl. G06F 3/041

(52) U.S. Cl. 345/173

(57) ABSTRACT

A touch-sensing panel including a substrate, a logo pattern, a decoration layer, and a touch-sensing element is provided. The logo pattern is disposed on the substrate. The decoration layer is disposed on surface periphery of the substrate, wherein the logo pattern is disposed between the substrate and the logo pattern. The touch-sensing element is disposed on the substrate. In this way, the layout and the fabrication margins of the touch-sensing panel are increased, and the design sense of the touch-sensing panel is enhanced. Besides, a touch-sensing display apparatus having the above touch-sensing panel is also provided.

### CROSS-REFERENCE TO RELATED APPLICATION

This application claims the priority benefit of Taiwan application serial no. 100128937, filed on Aug. 12, 2011. The entirety of the above-mentioned patent application is hereby incorporated by reference herein and made a part of this specification.

### BACKGROUND OF THE INVENTION

1. Field of the Invention

The invention relates to a touch-sensing panel. Particularly, the invention relates to a touch-sensing panel with a decoration layer located on a logo pattern, and a method for fabricating the same.

2. Description of Related Art

Referring to FIG. 1A, a touch-sensing panel 100 has a touch-sensing element 120, a light-shielding layer 130 and a logo pattern 140, where the touch-sensing element 120 includes sensing electrodes 122 and transmission lines 124, and the light-shielding layer 130 is used for shielding the transmission lines 124 to avoid the user viewing the transmission line 124 during utilization.

Referring to FIG. 1B, in the conventional touch-sensing panel 100, the underlying light-shielding layer 130 is first used to fabricate an opening H to serve as a predetermined position of the logo pattern. Then, the metal logo pattern 140 is plated on the predetermined position of the logo pattern. However, the logo pattern 140 fabricated according to the above method is lack of protection and is exposed to the outside, which is easy to be oxidized during fabrication to cause a color variation, so that a whole qualitative sense of the touch-sensing panel is greatly reduced.

Moreover, referring to FIG. 1A and FIG. 1B, when a layout of the transmission lines 124a and 124b is overlapped to the logo pattern, an additional process of adding an insulation layer 150 is required to isolate the transmission line 124 and the metal logo pattern 140, so as to avoid the signals of the transmission lines 124 from interfering by the metal logo pattern 140. However, even if the insulation layer 150 is disposed on the metal logo pattern 140, since the logo pattern 140 protrudes out from a surface of the light-shielding layer 130, the insulation layer 150 disposed between the logo pattern 140 and the transmission lines 124a and 124b may have a severe capacitor effect due to inadequate thickness, which may even influence signal transmission of the transmission lines 124. Therefore, the transmission lines 124a and 124b shown by dot lines in FIG. 1A may adopt a circuitous design, which may decrease flexibility in circuit layout and fabrication of the touch-sensing panel.

### SUMMARY OF THE INVENTION

The invention is directed to a touch-sensing panel, which increases flexibility in circuit layout and fabrication of the touch-sensing panel, and improves a design sense of the touch-sensing panel.

The invention provides a touch-sensing panel including a substrate, a logo pattern, a decoration layer, and a touch-sensing element. The logo pattern is disposed on the substrate. The decoration layer is disposed on surface periphery of the substrate, wherein the logo pattern is disposed between the substrate and the decoration layer. The touch-sensing element is disposed on the substrate.

According to the above descriptions, the touch-sensing panel of the invention applies a structure that the logo pattern is disposed between the substrate and the decoration layer. Therefore, the logo pattern is avoided to be directly exposed to the outside, and even if a material of the logo pattern is metal, an original color thereof can still be maintained for a long time, so as to maintain a qualitative sense of the touch-sensing panel. Moreover, the transmission line of the touch-sensing element can also be located above the logo pattern through isolation of the decoration layer without additional disposing an insulation layer on the logo pattern to avoid interfering signal transmission, so that the touch-sensing panel may have diversified choices in circuit layout, which improves flexibility in fabrication of the touch-sensing panel.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are respectively a top view and a cross-sectional view of a conventional touch-sensing panel.

FIG. 2A and FIG. 2B are respectively a top view and a cross-sectional view of a touch-sensing panel according to a first embodiment of the invention.

FIG. 3 is a cross-sectional view of a touch-sensing panel according to the first embodiment of the invention.

FIGS. 4A-4C are diagrams illustrating a method for fabricating a touch-sensing panel according to a second embodiment of the invention.

FIG. 5 is a cross-sectional view of a touch-sensing panel according to the second embodiment of the invention.

FIGS. 6A-6D and FIGS. 7A-7D are diagrams illustrating two methods for fabricating a touch-sensing panel according to the second embodiment of the invention.

FIG. 8 is a structural schematic diagram of a touch-sensing unit of a touch-sensing element in a touch-sensing panel according to an embodiment of the invention.

FIGS. 9-13 illustrate a plurality of cross-sectional structures of a touch-sensing unit of a touch-sensing element in a touch-sensing panel.

FIG. 14 and FIG. 15 are structural cross-sectional views of touch-sensing apparatus applying a touch-sensing panel.

FIG. 16 is a cross-sectional view of a touch-sensing display apparatus according to an embodiment of the invention.

FIG. 17 is a structural schematic diagram of a touch-sensing apparatus according to an embodiment of the invention.

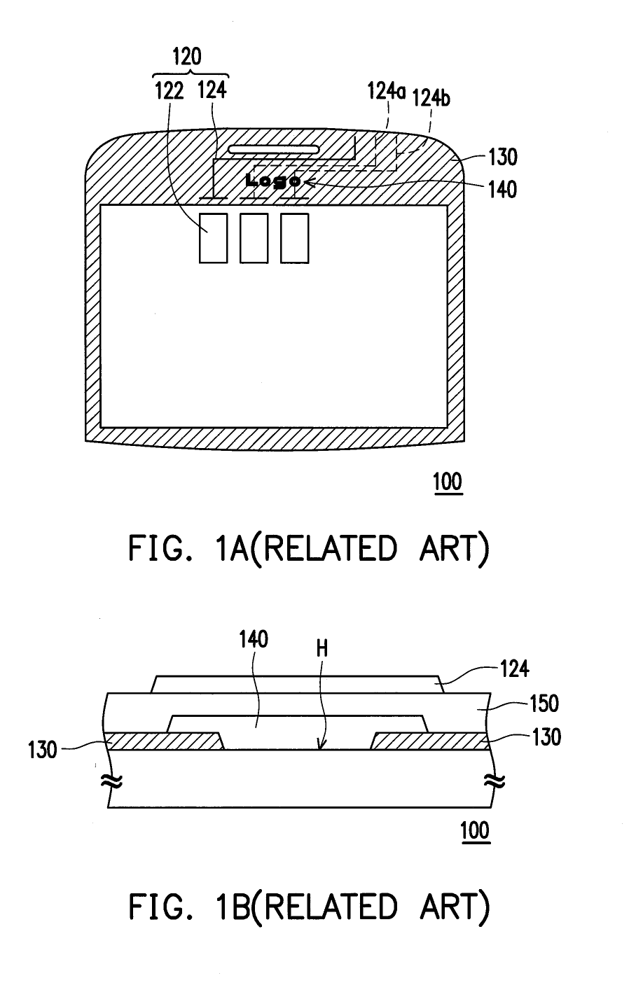

### DETAILED DESCRIPTION OF DISCLOSED EMBODIMENTS

### First Embodiment

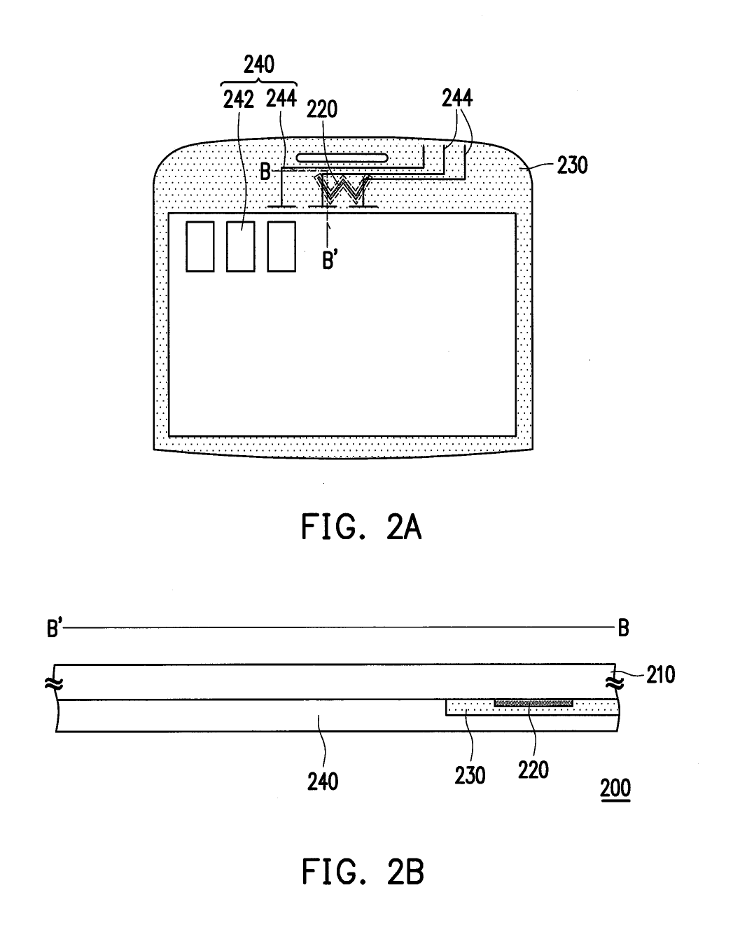

Referring to FIG. 2A and FIG. 2B, FIG. 2B is a cross-sectional view of FIG. 2A along a section line BB′. A touch-sensing panel 200 includes a substrate 210, a logo pattern 220, a decoration layer 230 and a touch-sensing element 240. The touch-sensing element 240 is disposed on the substrate 210. In the embodiment, the touch-sensing element 240 includes at least one touch-sensing unit 242 and at least one transmission line 244 electrically connected to the touch-sensing unit 242. The logo pattern 220 is disposed at a predetermined position on the substrate 210, and a designer can present a brand logo, a key icon or any desired figure on such region through the logo pattern 220. The decoration layer 230 is disposed on surface periphery of the substrate 210.

The decoration layer 230 of the present embodiment wraps the logo pattern 220 on the substrate 210, so that the logo pattern 220 is not exposed to the outside to cause oxidation, and decrease of qualitative sense thereof due to color variation is avoided. A material of the logo pattern 220 or the decoration layer 230 can be one of a metal plating film, ceramic, diamond-like carbon, a semipermeable membrane and a multi-layer film, or a combination thereof.

Moreover, a layout shape of the decoration layer 230 on the substrate 210 is not limited to a border frame shape as that shown in FIG. 2A, and in other embodiments, the decoration layer 230 can also be only formed at a local area on the surface periphery of the substrate 210 to present a bar-shape pattern, an L-shape pattern, π-shape pattern, or other shape patterns. Moreover, the material of the decoration layer 230 can be a transparent material or an opaque material, which is not limited by the invention.

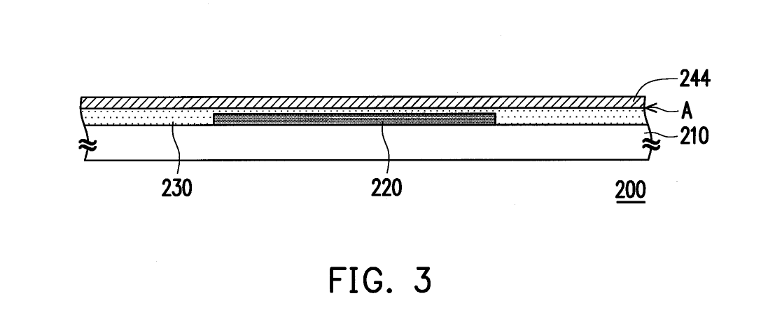

Referring to FIG. 2A and FIG. 3, in the present embodiment, when the transmission line 244 of the touch-sensing element 240 extends to the top of the logo pattern 220, the decoration layer 230 disposed between the logo pattern 220 and the transmission line 244 can directly serve as an insulation layer between the transmission line 244 and the logo pattern 220 without additionally configuring another insulation layer to isolate the logo pattern 220 and the transmission line 244. In this way, a layout region of the transmission line is not limited by the logo pattern 220, as shown in FIG. 3, the transmission line 244 can be directly disposed on the decoration layer 230 above the logo pattern 220 under a premise of maintaining a device characteristic. Even more, in some special cases, an insulation layer can be disposed at a position A between the transmission line 244 and the decoration layer 230 (i.e. disposed between the decoration layer 230 and the transmission line 244), and a film layer structure between the transmission line 244 and the decoration layer 230 is not limited by the invention, which can be suitably adjusted according to a product requirement or the device characteristic.

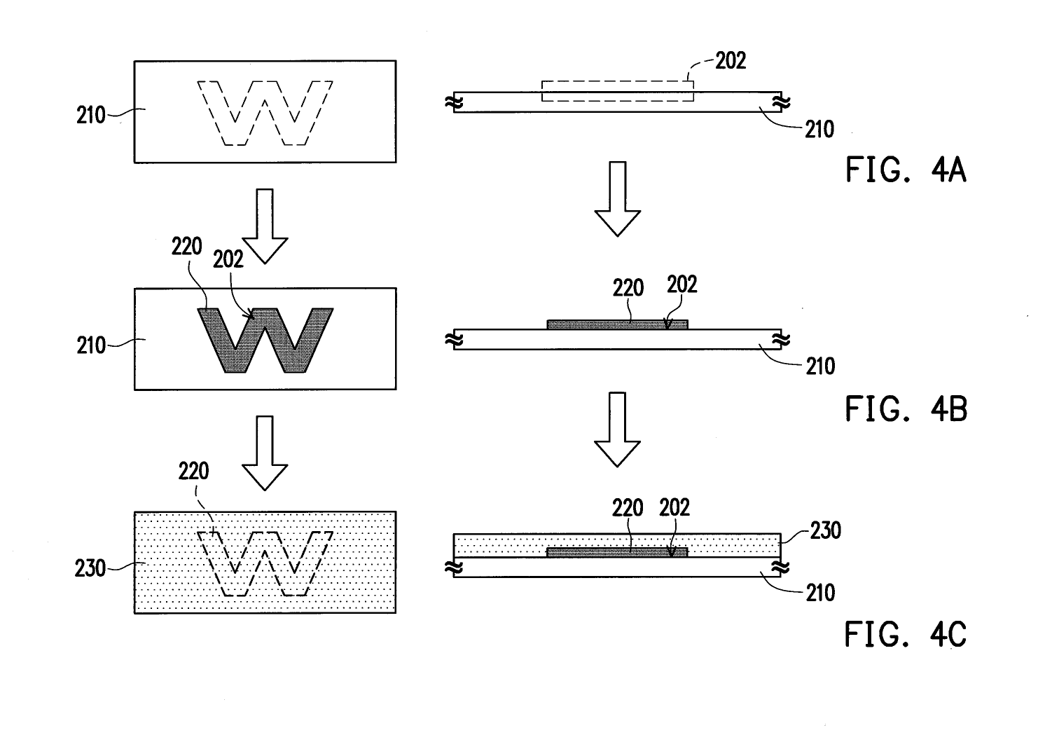

To clearly describe the touch-sensing panel 200, a method for fabricating the touch-sensing panel according to a second embodiment of the invention on the substrate is described with reference of FIGS. 4A-4C. In the top views of FIGS. 4A-4C, only structures related to the substrate 210, the logo pattern 220 and the decoration layer 230 are schematically illustrated, and other possible components are omitted.

Referring to FIG. 4A and FIG. 2A, first, the substrate 210 is provided, and the substrate 210 has a logo pattern predetermined position 202, where the substrate 210 is, for example, a glass or plastic substrate, etc.

Then, referring to FIG. 4B and FIG. 2A, the logo pattern 220 is formed on the substrate 210.

Then, referring to FIG. 4C and FIG. 2A, a decoration layer 230 is formed on surface periphery of the substrate 210 (shown in FIG. 2A). In the present embodiment, the decoration layer 230 covers the logo pattern 220 and the substrate 210. Therefore, the decoration layer 230 can serve as a protection layer of the logo pattern 220. Moreover, the touch-sensing element 240 (shown in FIG. 2A) is formed on the substrate 210 to form the touch-sensing panel 200 shown in FIG. 2A and FIG. 2B, or the transmission line 244 (shown in FIG. 2A) of the touch-sensing element 240 extends to the top of the logo pattern 220 to form the touch-sensing panel 200 shown in FIG. 2A and FIG. 3. The logo pattern 220 and the touch-sensing element 240 are configured in collaboration, and a fabrication sequence thereof is not limited by the invention.

### Second Embodiment

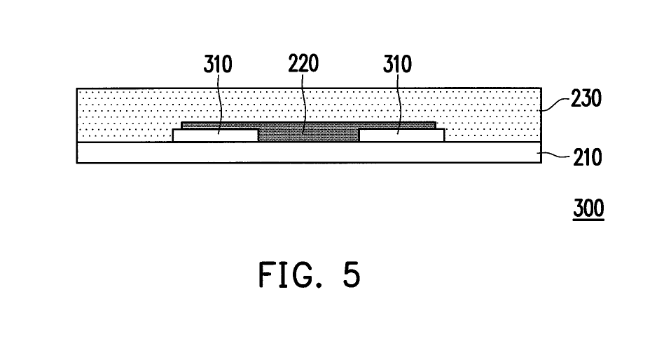

Referring to FIG. 5, a touch-sensing panel 300 of the present embodiment is similar to the touch-sensing panel 200 of the first embodiment, and the same components are denoted by the same symbols. Though, compared to the touch-sensing panel 200 of the first embodiment, the touch-sensing panel 300 of the present embodiment further has a color matching layer 310.

In order to further increase a special visual variation of the logo pattern 220 to achieve an optimal visual effect, the color matching layer 310 is disposed on the logo pattern 220. A material of the color matching layer 310 can be photoresist of different colors, ceramic, ink or diamond-like carbon, etc. according to an actual product design or color matching requirement, for example, a red filter photoresist, a blue filter photoresist or a green filter photoresist of a color filter layer. As a color of the color matching layer 310 is different to a color of the decoration layer 230, the logo pattern 220 may present a special visual effect such as a 3D or a shadow visual effect, etc., by which the design sense and the qualitative sense of the touch-sensing panel are improved.

In detail, in the present embodiment, the color matching layer 310 is circularly disposed around the logo pattern 220 to, for example, form a local font of the logo pattern 220 or a base line of the logo pattern 220, etc., and the pattern and shape of the color matching layer 310 is not limited by the invention.

Particularly, the color matching layer 310 and the logo pattern 220 are both disposed between the substrate 210 and the decoration layer 230. Therefore, the decoration layer 230 can also serve as a protection layer of the color matching layer 310 and the logo pattern 220.

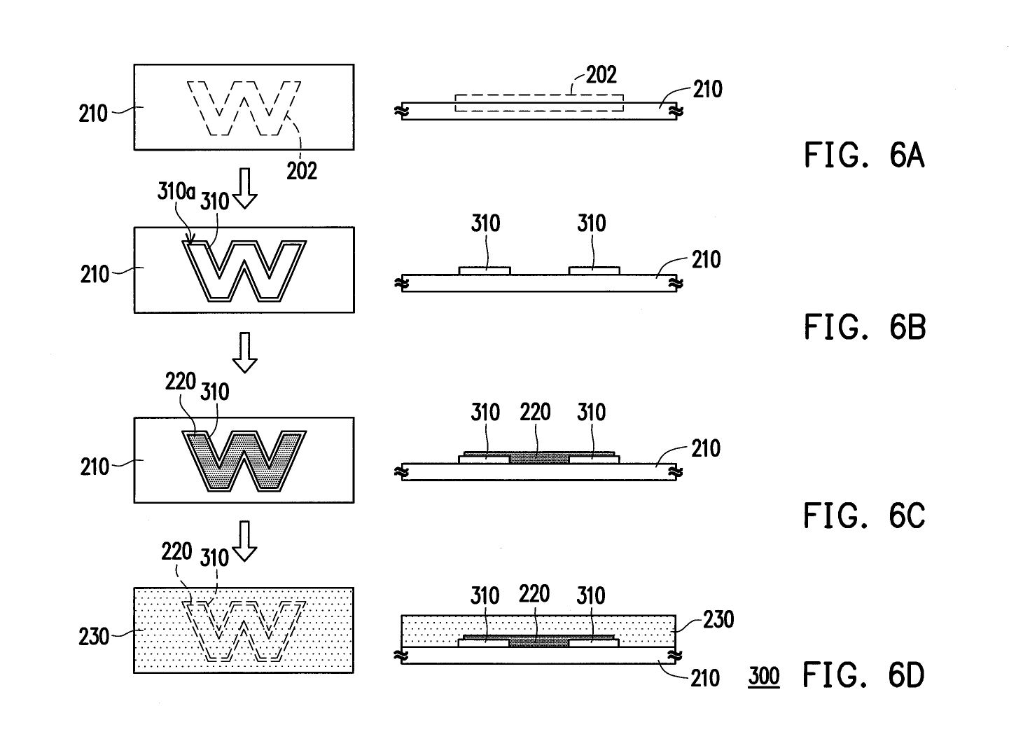

A method for fabricating the touch-sensing panel according to the second embodiment of the invention is described with reference of FIGS. 6A-6D.

Referring to FIG. 6B, the color matching layer 310 is first formed on the logo pattern predetermined position 202 on the substrate 210, where a material of the color matching layer is photoresist, diamond-like carbon, ink or ceramic, etc.

Then, referring to FIG. 6C, after the color matching layer 310 is formed, the logo pattern 220 is formed on a logo border frame 310a encircled by the color matching layer 310.

Referring to FIG. 6D, when the decoration layer 230 is formed, the decoration layer 230 simultaneously covers the logo pattern 220 and the color matching layer 310. Therefore, the decoration layer 230 can simultaneously serve as a protection layer of the logo pattern 220 and the color matching layer 310 to avoid exposing the logo pattern 220.

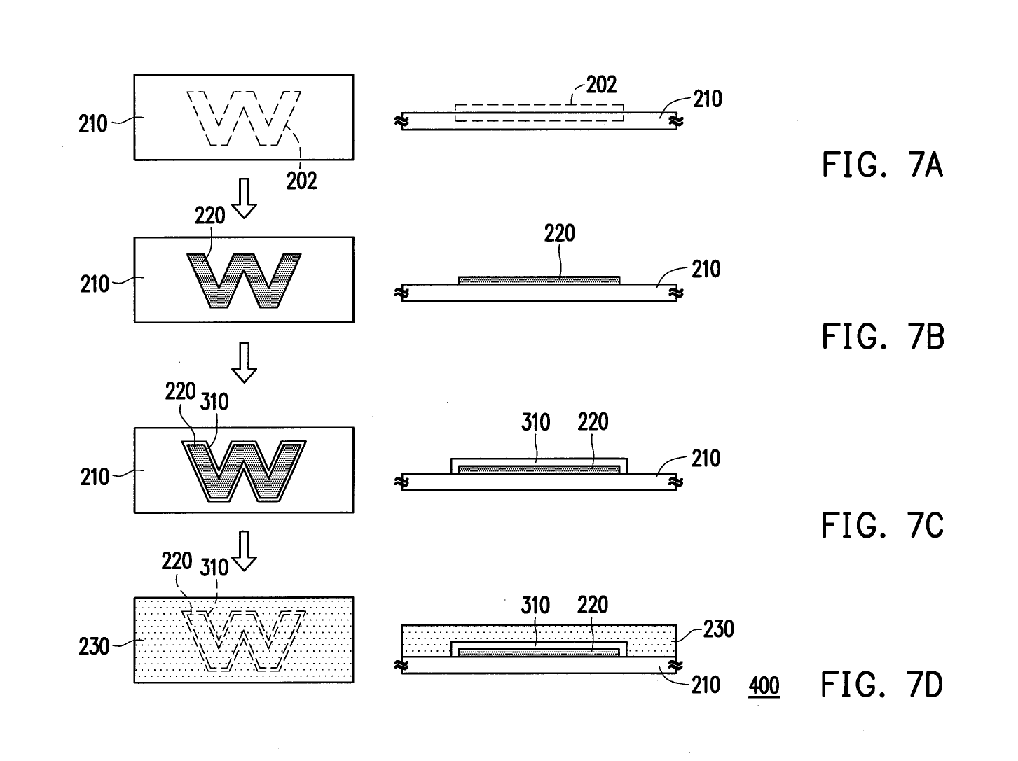

FIGS. 7A-7D illustrate a method for fabricating the logo pattern 220 of another touch-sensing panel according to the second embodiment of the invention. However, in the present embodiment, the step of forming the color matching layer 310 is behind the step of forming the logo pattern 220.

Referring to FIG. 7B, the logo pattern 220 is first formed on the substrate 210. Then, referring to FIG. 7C, the color matching layer 310 is formed on the logo pattern 220. Shown as a right part of FIG. 7C, the color matching layer 310 directly covers the logo pattern 220. Certainly, the color matching layer 310 can be only formed on the border frame of the logo pattern 220 as that shown in FIG. 6B, and the shape and pattern of the color matching layer 310 is not limited by the invention. The subsequent fabrication process is the same to that of the touch panel 300, which is not repeated herein. The decoration layer 230 of the present embodiment can also be used as a protection layer of the logo pattern 220 and the color matching layer 310.

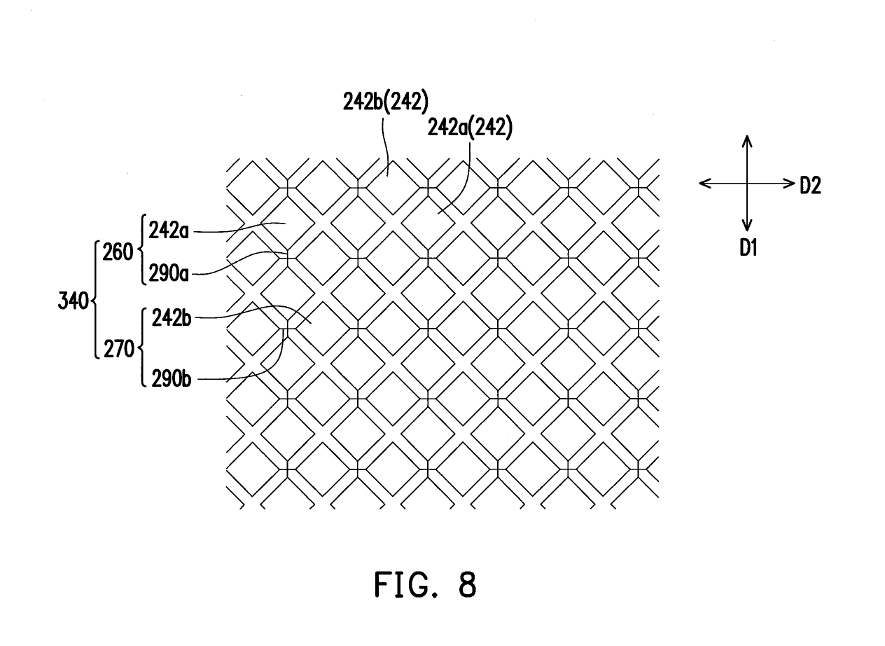

A structure of the touch-sensing element in the touch-sensing panel of the invention can be a single-layer transparent electrode structure or a multi-layer transparent electrode structure, and the structure of the touch-sensing element is not limited to be disposed at one side of two sides of the substrate, which is described below with reference of FIG. 8. FIG. 8 is a structural schematic diagram of a touch-sensing unit in a touch-sensing panel according to an embodiment of the invention.

Referring to FIG. 8, the touch-sensing unit 340 includes a plurality of first sensing series 260 extending along a first direction D1 and a plurality of second sensing series 270 extending along a second direction D2. The first sensing series 260 and the second sensing series 270 are isolated to each other.

Each of the first sensing series 260 is formed by first sensing electrodes 242a extended along the first direction D1, and each of the second sensing series 270 is formed by sensing electrodes 242 extended along a different direction, for example, second sensing electrodes 242b extended along the second direction D2, where the first direction D1 is perpendicular to the second direction D2. Two adjacent first sensing electrodes 242a on each of the first sensing series 260 are electrically connected through a first bridge line 290a, and two adjacent second sensing electrodes 242b on each of the second sensing series 270 are electrically connected through a second bridge line 290b. Each of the first sensing electrodes and the second sensing electrodes may have a geometric shape such as a diamond, a triangle, or a linear shape, etc.

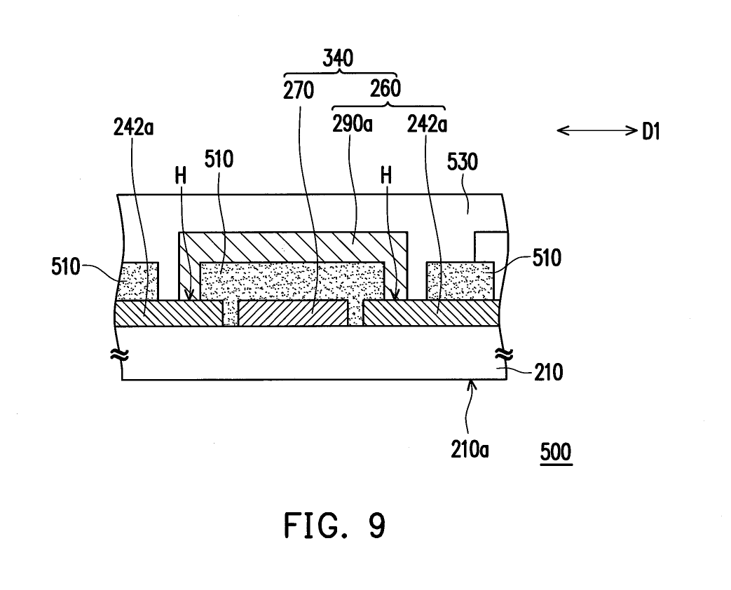

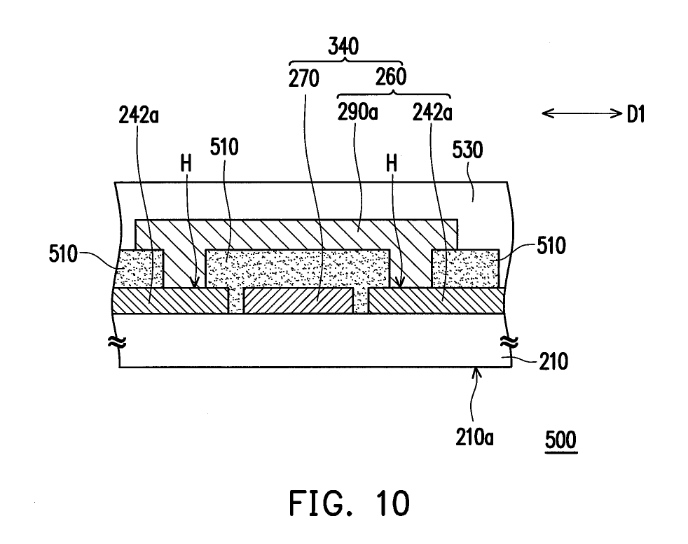

Cross-sectional structures of the touch-sensing element are illustrated in FIG. 9 to FIG. 13. Referring to FIG. 9 and FIG. 10, the touch-sensing panel 500 includes a touch-sensing element 340, an insulation layer 510, a bridge line 520 and a protection layer 530 located on the substrate 210, and an operating surface 210a is located at a side of the substrate 210 back to the touch-sensing element 340. As shown in FIG. 9 and FIG. 10, the touch-sensing element 340 includes a first sensing series 260 and a second sensing series 270. In the present embodiment, the first sensing series 260 has a plurality of first sensing electrodes 242a and a first bridge line 290a electrically connected to the first sensing electrode 242a. The insulation layer 510 covers the first sensing series 260 and the second sensing series 270, and the insulation layer 510 has openings H exposing the first sensing electrode 242a at two ends of each of the first sensing electrodes 242a along the first direction D1. As shown in FIG. 9 and FIG. 10, two adjacent first sensing electrodes 242a are electrically connected through the first bridge line 290a. However, a material of the first bridge line 290a shown in FIG. 9 is metal or other conductive materials, and a material of the first bridge line 290a shown in FIG. 10 is a transparent conductive material. In other words, the touch-sensing elements 340 of FIG. 9 and FIG. 10 all have a bridge via design.

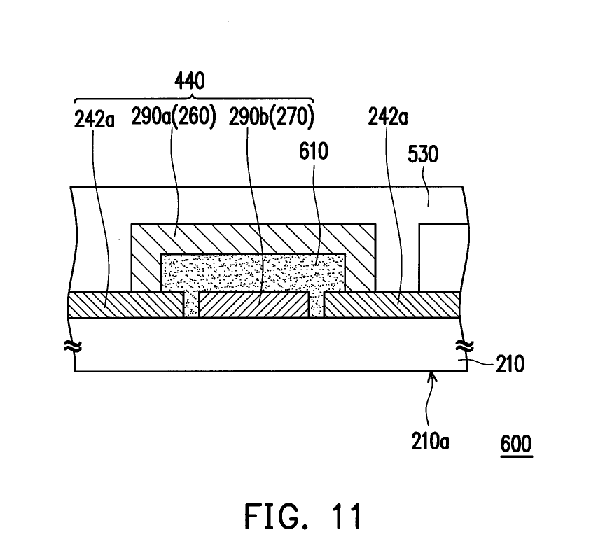

In another embodiment, referring to FIG. 11, a structure of a touch-sensing element 440 is similar the embodiment illustrated in FIG. 9 and FIG. 10, through in a touch-sensing panel 600 of the present embodiment, an island-like insulation pattern 610 is used to replace the insulation layer 510 of FIG. 9 and FIG. 10. Referring to FIG. 9 and FIG. 11, the insulation pattern 610 is only disposed between the first bridge line 290a of the first sensing series 260 and the second bridge line 290b of the second sensing series 270. In other words, the touch-sensing element 440 of FIG. 11 has a bridge island design.

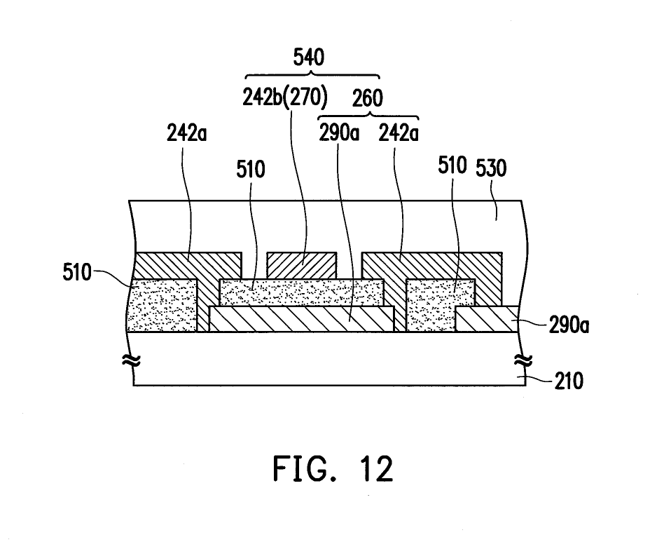

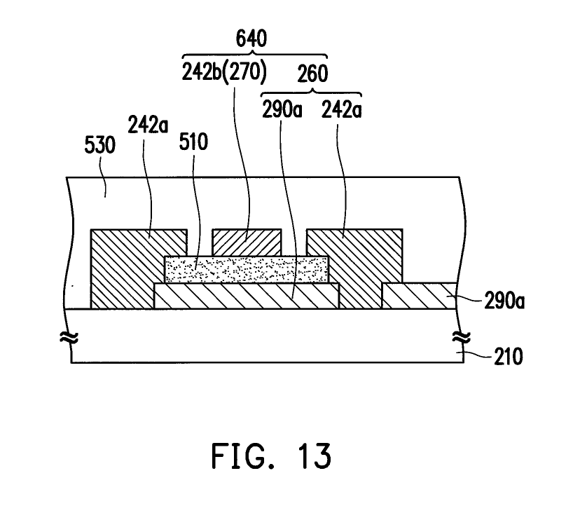

However, in FIG. 12 and FIG. 13, the first bridge line 290a is first fabricated, and then the first sensing electrodes 242a and the second sensing electrodes 242b are fabricated. Namely, in structures of a touch-sensing element 540 of FIG. 12 and a touch-sensing element 640 of FIG. 13, the first bridge line 290a is located between the insulation layer 510 and the substrate 210, and the first sensing electrodes 242a and the second sensing electrodes 242b are located on the insulation layer 510.

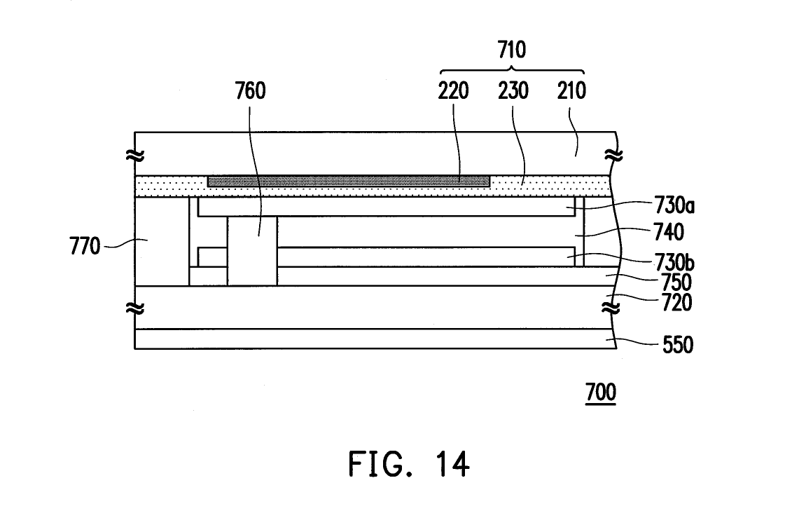

Referring to FIG. 14, a touch-sensing apparatus 700 includes a front substrate 710 and a back substrate 720. The front substrate 710 is any of the touch-sensing panels of the aforementioned embodiments, and in the present embodiment, the front substrate 710 is, for example, the touch-sensing panel 200 of FIG. 2B. A first transparent electrode 730a and a second transparent electrode 730b are respectively disposed on opposite surfaces of the front substrate 710 and the back substrate 720, and an optical adhesive 740 is disposed between the two transparent electrodes 730a and 730b.

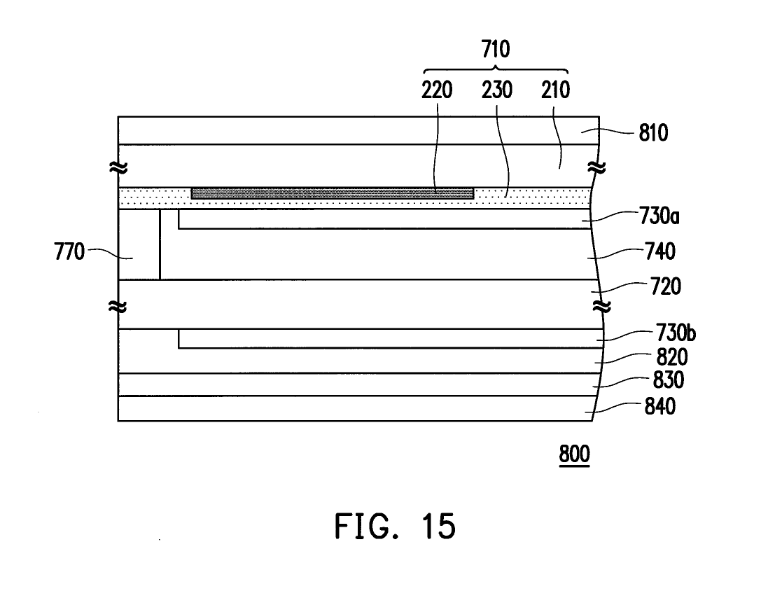

Referring to FIG. 15, a touch-sensing apparatus 800 has the front substrate 710 implemented by any of the touch-sensing panels of the aforementioned embodiments (for example, the touch-sensing panel 200) and the back substrate 720. The first transparent electrode 730a is disposed on a surface of the front substrate 710 facing to the back substrate 720, and the second transparent electrode 730b is on a surface of the back substrate 720 back to the front substrate 710. The optical adhesive 740 is disposed between the first transparent electrode 730a of the front substrate 710 and the back substrate 720, and a sealant 770 is used to seal the internal devices between the two substrates 710 and 720.

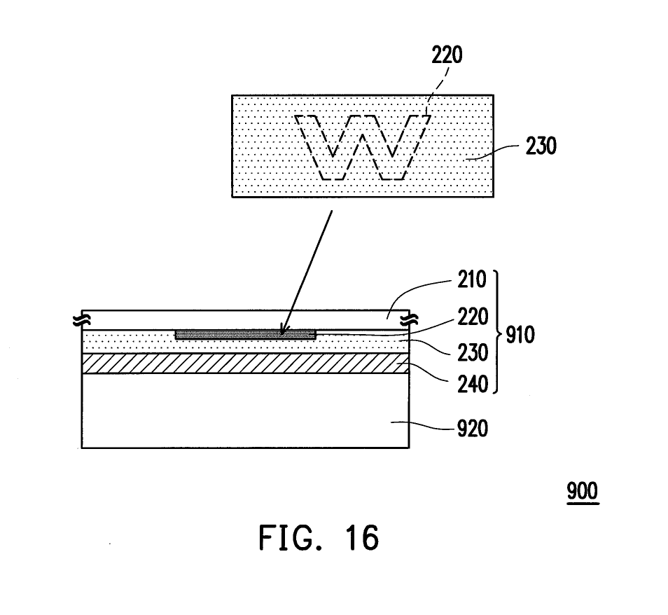

Moreover, each of the touch-sensing panels of the aforementioned embodiments can be combined with a display panel to form a touch-sensing display apparatus. For example, as shown in FIG. 16, a display panel 920 can be adhered to a touch-sensing panel 910 through an optical adhesive to form a touch-sensing display apparatus 900, where the touch-sensing panel 910 can be any of the touch-sensing panels of the aforementioned embodiments. Here, the touch-sensing panel 200 of FIG. 3 is taken as an example, which includes the substrate 210, the logo pattern 220 (as that shown in a top view diagram of the figure), the decoration layer 230 and the touch-sensing element 240. The type of the display panel 920 is not limited, which can be a liquid crystal display, an organic light-emitting display, an electrowetting display or an electrophoretic display, etc.

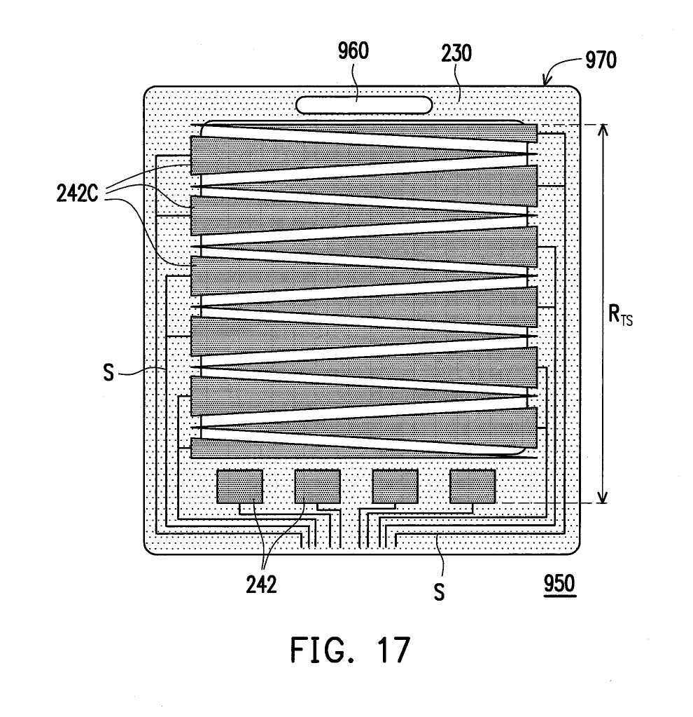

FIG. 17 is a structural schematic diagram of a touch-sensing panel according to an embodiment of the invention. Referring to FIG. 17, the touch-sensing unit 950 includes a cover lens 970, wherein the cover lens 970 includes a decoration layer 230 disposed on the periphery region, sensing electrodes 242C having triangle-shaped and arranged in a mono layer in the touch-sensing region R_{TS}. Moreover, the cover lens 970 includes sensing electrodes 242 on the periphery region, and signal lines S respectively connected between the sensing electrodes 242C in the touch-sensing region R_{TS} and the corresponding sensing electrodes 242 on the periphery region. Furthermore, the decoration layer 230 has an opening 960 which can place in a predetermined position of the logo pattern.

In summary, in the touch-sensing panel and the method for fabricating the same of the invention, the logo pattern is avoided to be directly exposed to the outside, so as to maintain a whole qualitative sense of the touch-sensing panel. Moreover, the transmission line of the touch-sensing element can be disposed above the logo pattern through isolation of the decoration layer, by which interference of signal transmission is avoided, and flexibility in circuit layout and fabrication of the touch-sensing panel is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch-sensing panel, comprising:
a substrate;
a logo pattern, disposed on the substrate;
a decoration layer, disposed on a surface of the substrate, wherein the logo pattern is disposed between the substrate and the decoration layer; and
a touch-sensing element, disposed on the substrate.

2. The touch-sensing panel as claimed in claim 1, wherein a material of the logo pattern comprises one of a metal plating film, diamond-like carbon, ceramic, ink, a semipermeable membrane and a multi-layer film, or a combination thereof.

3. The touch-sensing panel as claimed in claim 1, wherein a material of the decoration layer comprises photoresist, diamond-like carbon, ceramic or ink.

4. The touch-sensing panel as claimed in claim 1, further comprising a color matching layer, wherein the color matching layer and the logo pattern are disposed between and the substrate and the decoration layer.

5. The touch-sensing panel as claimed in claim 1, wherein the touch-sensing element comprises at least one touch-sensing unit and at least one transmission line electrically connected to the touch-sensing unit, wherein the transmission line extends to the top of the decoration layer and the logo pattern.

6. The touch-sensing panel as claimed in claim 1, wherein the decoration layer is located at surface periphery of the substrate.

7. The touch-sensing panel as claimed in claim 4, wherein the color matching layer is circularly disposed around the logo pattern.

8. A touch-sensing display apparatus, comprising:
a touch-sensing panel, comprising:
a substrate;
a logo pattern, disposed on the substrate;
a decoration layer, disposed on surface periphery of the substrate, wherein the logo pattern is disposed between the substrate and the decoration layer;
a touch-sensing element, disposed on the substrate; and
a display panel, disposed on the touch-sensing panel.

9. The touch-sensing display apparatus as claimed in claim 8, wherein the touch-sensing element is located between the substrate and the display panel.
